(19) United States
(12) Patent Application Publication
(10) Pub. No.: US 2020/0278743 A1
(43) Pub. Date: Sep. 3, 2020

(54) CONTROL DEVICE

(71) Applicant: TOYOTA JIDOSHA KABUSHIKI KAISHA, Toyota-shi (JP)

(72) Inventor: Daisuke HIROKI, Okazaki-shi (JP)

(73) Assignee: TOYOTA JIDOSHA KABUSHIKI KAISHA, Toyota-shi (JP)

(21) Appl. No.: 16/744,270

(22) Filed: Jan. 16, 2020

(30) Foreign Application Priority Data
Mar. 1, 2019 (JP) 2019-037733

(51) Int. Cl. G06F 3/01; G07C 5/02; G07C 5/08; B60R 1/00; B60R 11/04

(52) U.S. Cl. CPC G06F 3/011; G07C 5/02; B60R 2300/70; B60R 1/00; B60R 11/04; G07C 5/08

(57) ABSTRACT

The control device includes an occupant imaging unit, a posture discernment unit configured to discern the posture of the occupant or a change in posture based on an image captured by the occupant imaging unit, a vehicle state acquisition unit configured to acquire a signal indicating the state of the vehicle or the state of the vicinity of the vehicle, a vehicle state discernment unit configured to discern the state of the vehicle or the state of the vicinity of the vehicle based on the acquired signal, a control content specifying unit configured to specify a display to be controlled and content to be displayed on the display based on the result of the discernment performed by the posture discernment unit and the vehicle state discernment unit, and a controller configured to control display change of the display to be controlled based on the result of the specification.

### INCORPORATION BY REFERENCE

The disclosure of Japanese Patent Application No. 2019-037733 filed on Mar. 1, 2019 including the specification, drawings and abstract is incorporated herein by reference in its entirety.

### BACKGROUND

### 1. Technical Field

The disclosure relates to a control device for a display installed in a vehicle.

### 2. Description of Related Art

A technique in which the state of the vicinity or the inside of a vehicle is imaged by a vehicle-mounted camera and is displayed on a display such as an electronic side mirror, an electronic inner rearview mirror, and a car navigation device has become a common technique. The display can selectively display the whole or a portion of a captured image. In addition, in a case where a plurality of displays or a plurality of vehicle-mounted cameras is installed, it is possible to appropriately change an image to be displayed on the display by switching between the vehicle-mounted cameras for performing an imaging operation and switching between the displays for displaying a captured image. At this time, an image intended by a driver needs to be appropriately displayed on the display. For example, Japanese Unexamined Patent Application Publication No. 2017-196913 (JP 2017-196913 A) and Japanese Unexamined Patent Application Publication No. 2017-196911 (JP 2017-196911 A) disclose a technique in which an image intended by a driver is guessed based on the positions of the eyes of the driver or the direction of the line of sight of the driver and the range of an image to be displayed on a display, which is a portion of a captured image, is changed.

### SUMMARY

However, in techniques described in JP 2017-196913 A and JP 2017-196911 A, a camera or the like needs to correctly recognize the positions of the eyes or the line of sight. For example, in a case where the eyes cannot be accurately recognized due to the driver wearing sunglasses or the like, there is a possibility that a displaying operation cannot be appropriately performed. In addition, the image intended by the driver may be changed depending on the state a vehicle or the state of the vicinity of the vehicle. For example, even in the case of an image displayed on the same right electronic side mirror, the driver may desire that an image of a side that is behind and to the right of a vehicle is displayed when the vehicle travels normally and a wide-angle image of a side that is below the vehicle and is to the right of the vehicle is displayed when the vehicle moves backward. However, in methods described in JP 2017-196913 A and JP 2017-196911 A, the state of a vehicle or the state of the vicinity of the vehicle are not to be considered. Therefore, there is room for improvement.

The disclosure provides a control device that can cause a display to display an image intended by a driver more appropriately.

An aspect of the disclosure relates to a control device installed in a vehicle provided with a plurality of vehicle-mounted cameras and a plurality of displays, the control device being configured to perform control in which at least a portion of an image captured by any of the vehicle-mounted cameras is displayed on any of the displays. The control device includes an occupant imaging unit, a posture discernment unit, a vehicle state acquisition unit, a vehicle state discernment unit, a control content specifying unit, and a controller. The occupant imaging unit is configured to image an occupant in the vehicle. The posture discernment unit is configured to discern the posture of the occupant or a change in posture based on an image captured by the occupant imaging unit. The vehicle state acquisition unit is configured to acquire a signal indicating the state of the vehicle or the state of the vicinity of the vehicle. The vehicle state discernment unit is configured to discern the state of the vehicle or the state of the vicinity of the vehicle based on the signal acquired by the vehicle state acquisition unit. The control content specifying unit is configured to specify a display to be controlled and content to be displayed on the display based on the result of the discernment performed by the posture discernment unit and the vehicle state discernment unit. The controller is configured to control display change of the display to be controlled based on the result of the specification performed by the control content specifying unit.

According to the aspect of the disclosure, it is possible to provide s a control device that can cause a display to display an image intended by a driver more appropriately.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a functional block diagram illustrating the configuration of a control device according to an embodiment of the disclosure;

FIG. 2A is an example of data for narrowing down targets to be controlled and the content of control;

FIG. 2B is an example of data for narrowing down targets to be controlled and the content of control;

FIG. 3 is a flowchart for describing the procedure a control process performed by the control device;

FIG. 4 is a flowchart for describing a process for discerning a posture; and

FIG. 5 is a functional block diagram illustrating a control device according to another embodiment of the disclosure.

### DETAILED DESCRIPTION OF EMBODIMENTS

A control device according to an embodiment of the disclosure controls display change of a display based on the posture of an occupant or a change in posture and the state of a vehicle or the state of the vicinity of the vehicle. Accordingly, it is possible to cause the display to display an image intended by a driver more appropriately.

### Embodiment

Hereinafter, an embodiment of the disclosure will be described with reference to drawings.

Configuration

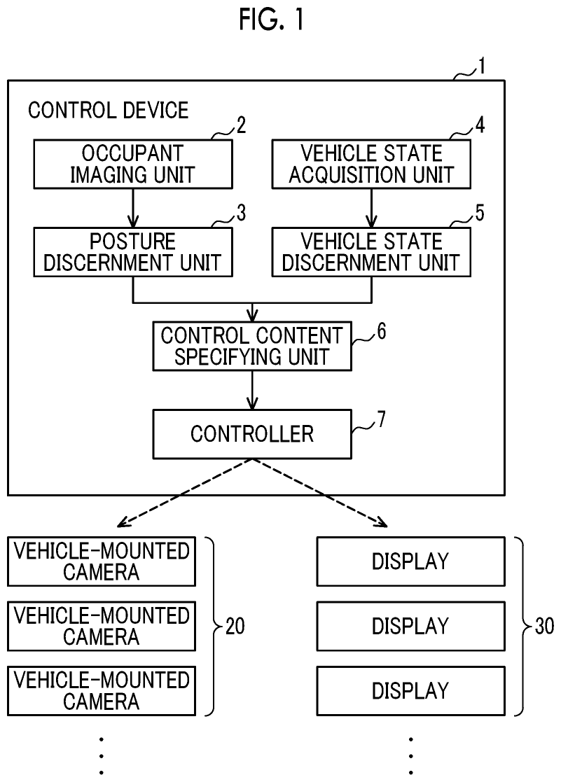

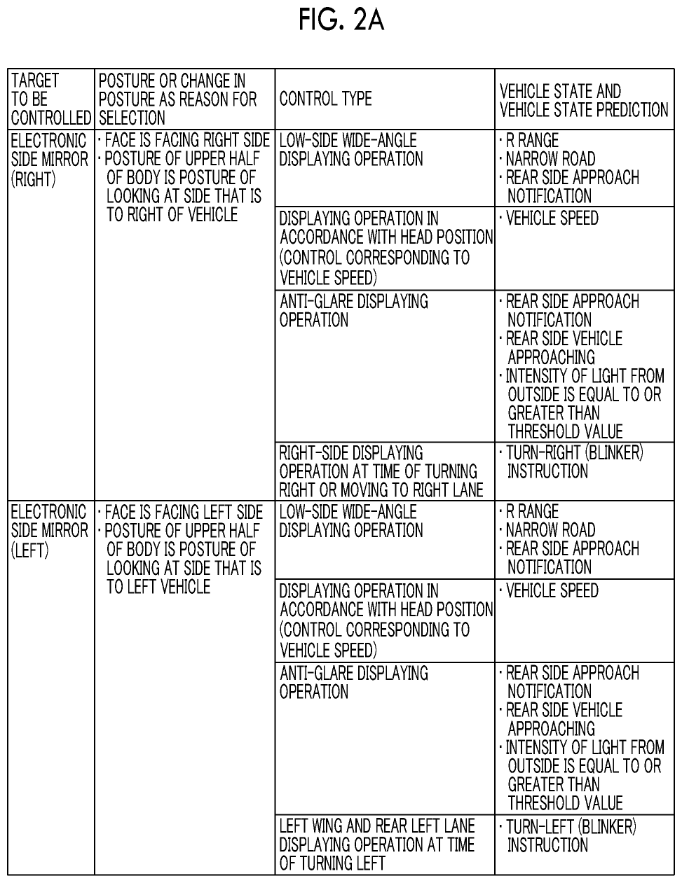

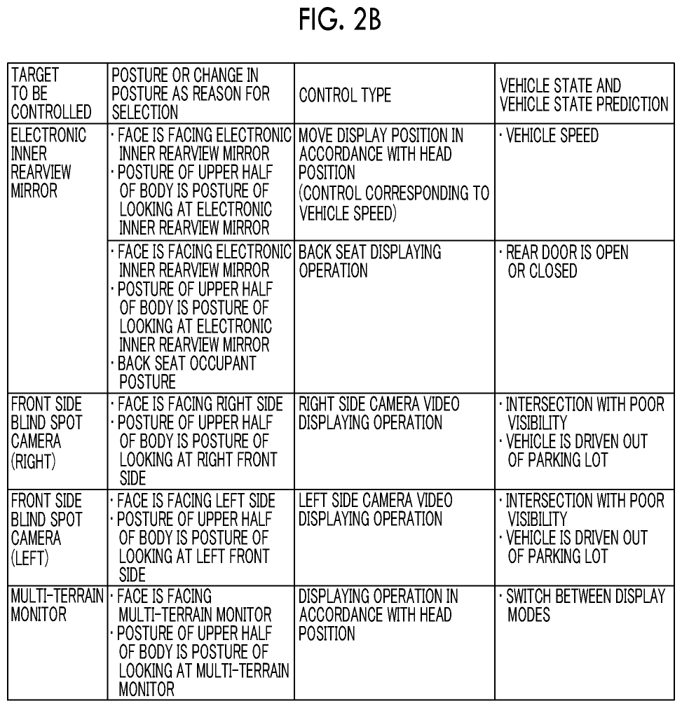

FIG. 1 is a functional block diagram illustrating the configuration of the control device according to the embodiment of the disclosure. A control device 1 is provided with an occupant imaging unit 2, a posture discernment unit 3, a vehicle state acquisition unit 4, a vehicle state discernment unit 5, a control content specifying unit 6, and a controller 7. The control device 1 is installed in a vehicle provided with a plurality of vehicle-mounted cameras 20 and a plurality of displays 30 and performs control in which at least a portion of an image captured by any of the vehicle-mounted cameras 20 is displayed on any of the displays 30. In addition, the control device 1 holds discernment information for specifying the display 30 to be controlled (target to be controlled) and content to be displayed on the display 30 to be controlled (control type) in advance. The discernment information is stored such that each of the displays 30 to be controlled is correlated with the posture of an occupant and a change in posture and each of control types is correlated with the state of the vehicle and the state of the vicinity of the vehicle and is information with which it is possible to specify the type of control to be performed on the display 30 to be controlled by using the posture of an occupant or a change in posture and the state of the vehicle or the state of the vicinity of the vehicle as retrieval keys. The discernment information can be represented by a table as shown in FIGS. 2A and 2B, for example.

The vehicle-mounted cameras 20 are, for example, electronic side mirror cameras, an electronic inner rearview mirror camera, a front side blind spot camera, and a multi-terrain monitor camera. The electronic side mirror cameras are a left side camera imaging a side that is to the left of the vehicle and a side that is behind and to the left of the vehicle and a right side camera imaging a side that is to the right of the vehicle and a side that is behind and to the right of the vehicle and the electronic side mirror cameras are installed at positions to which general optical type side mirrors are attached, for example. The electronic inner rearview mirror camera is a camera imaging a side behind the vehicle and is installed at a trunk lid of a vehicle rear portion, a tailgate, or the like. The front side blind spot camera is a camera imaging a blind spot in front of the vehicle. The front side blind spot camera may be installed at each of positions to which general right and left optical type side mirrors are attached and one front side blind spot camera may be installed in the vicinity of a license number plate or an emblem on a front side of the vehicle in a case where the angle of view of the camera is large, for example. The multi-terrain monitor camera is, for example, a camera imaging a road surface and is installed at a portion of a front bumper or at each of positions to which general optical type side mirrors are attached.

The displays 30 are, for example, electronic side mirrors, an electronic inner rearview mirror, and a screen used for car navigation or the like provided at the approximately central portion of a dashboard. The electronic side mirrors are respectively installed at both of right and left end portions of the dashboard. The electronic inner rearview mirror is, for example, installed at a position to which a general optical type inner rearview mirror is attached. The displays 30 can display images captured by the vehicle-mounted cameras 20. Basically, images captured by the electronic side mirror cameras are displayed on the electronic side mirrors, an image captured by an electronic inner rearview mirror camera is displayed on the electronic inner rearview mirror, and a video captured by the front side blind spot camera and the multi-terrain monitor camera is displayed on the screen used for car navigation or the like. However, an image captured by any of the vehicle-mounted cameras 20 may be displayed on any of the displays 30 as needed.

The occupant imaging unit 2 is a camera imaging an occupant such as a driver and is, for example, installed at the position of the electronic inner rearview mirror. The above-described camera is installed separately from the vehicle-mounted cameras 20.

The posture discernment unit 3 discerns the posture of the occupant or a change in posture based on an image captured by the occupant imaging unit 2. In the present embodiment, the posture means the orientation of a face, the position of a head, the posture, or the like. In addition, the meaning of “to discern a change in posture” is the same as the meaning of “to discern the purpose of an action of the occupant”. As specific examples of the posture or the change in posture, for example, those described in “posture or change in posture as reason for selection” shown in FIGS. 2A and 2B can be used.

The vehicle state acquisition unit 4 acquires a signal indicating the state of the vehicle or the state of the vicinity of the vehicle. The signal indicating the state of the vehicle and the state of the vicinity of the vehicle can be obtained from various sensors installed in the vehicle, cameras (that may include vehicle-mounted cameras 20), the global positioning system (GPS), or the like.

The vehicle state discernment unit 5 discerns the state of the vehicle or the state of the vicinity of the vehicle based on the signal acquired by the vehicle state acquisition unit 4. The state of the vehicle is, for example, the state of the vehicle itself such as a vehicle speed, a shift position, the opening and closing states of doors, presence or absence of a blinker instruction, and presence or absence of rear side approach notification. The state of the vicinity of the vehicle is, for example, a state where the vehicle is in such as the position of the vehicle, the width of a road in the vicinity of the vehicle, the visibility on a road in the vicinity of the vehicle, the volume of traffic, presence or absence of a vehicle approaching from a rear side, a distance from the vehicle to a vehicle approaching from a rear side, the position and the approaching speed of a vehicle approaching from a rear side, and the intensity of light from the outside. As specific examples of the state of the vehicle and the state of the vicinity of the vehicle, for example, those described in “vehicle state or vehicle state prediction” shown in FIGS. 2A and 2B can be used. Note that, the vehicle state prediction will be described later.

The control content specifying unit 6 specifies the display 30 to be controlled and content to be displayed on the display 30 to be controlled based on the result of the discernment performed by the posture discernment unit 3 and the vehicle state discernment unit 5. Specifically, the control content specifying unit 6 can specify a target to be controlled and a control type by searching the discernment information as shown in FIGS. 2A and 2B while using the posture of the occupant or a change in posture discerned by the posture discernment unit 3 and the state of the vehicle or the state of the vicinity of the vehicle discerned by the vehicle state discernment unit 5 as retrieval keys. Note that, the control content specifying unit 6 may specify the display 30 to be controlled and content to be displayed on the display 30 to be controlled after the prospective state of the vehicle or the prospective state of the vicinity of the vehicle is predicted based on the result of the discernment performed by the vehicle state discernment unit 5.

The controller 7 performs control in a displaying operation of the display 30 to be controlled is changed based on the result of specification performed by the control content specifying unit 6. Specifically, the controller 7 performs control defined for the specified control type with respect to the specified display 30 to be controlled. Control Process

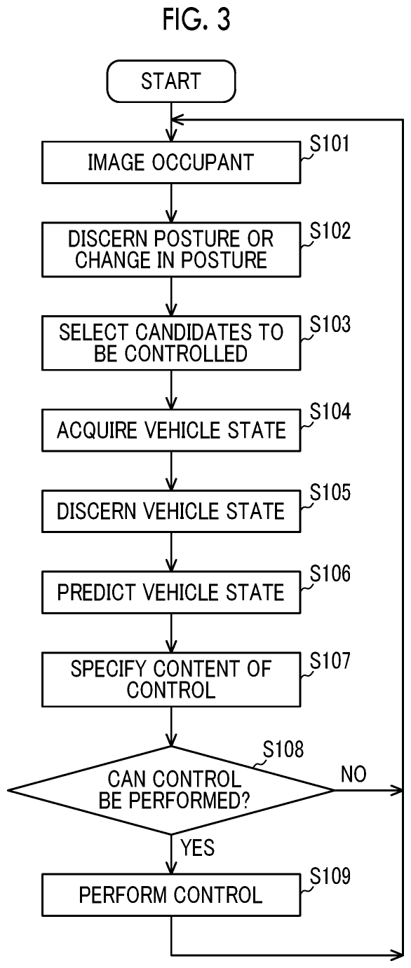

Control performed by the control device 1 will be described with reference to FIGS. 2A to 3. FIG. 3 is a flowchart for describing the procedure for a control process performed by the control device 1. The flow in FIG. 3 is started when an ignition of the vehicle is turned on (IG-ON) and is repeated until the ignition is turned off (IG-OFF).

Step S101: The occupant imaging unit 2 images an occupant. The length of a time for which the occupant is imaged, the number of frames, or the like may be set such that the posture of the occupant or a change in posture of the occupant to be discerned can be discerned. Thereafter, the process proceeds to step S102.

Step S102: The posture discernment unit 3 discerns the posture of the occupant or a change in posture based on an image captured by the occupant imaging unit 2. The posture of the occupant can be discerned based on a positional relationship between portions of a body such as a head, shoulders, elbows, and hands. For example, coordinates on the image captured by the occupant imaging unit 2 may be defined and the posture may be discerned based on a combination of the positional coordinates of skeleton points of the occupant. In addition, the image captured by the occupant imaging unit 2 may be divided into regions in a lattice-like shape and the posture may be discerned based on a shape formed by regions out of the divided regions with which the silhouette of the occupant overlaps. A method of dividing the regions in a lattice-like shape may be a method in which the occupant imaging unit 2 captures an image through a lattice-shaped frame or a method of performing image processing on an image captured by the occupant imaging unit 2. In addition, a change in posture is obtained by continuously observing the posture of the occupant. For example, the posture discernment unit 3 can discern, based on the line of sight of the occupant, the orientation of the face of the occupant, and/or a change in position of the head of the occupant, an action of looking at any of the right and left electronic side mirrors, an action of looking at a blind spot, and an action of looking at a road surface which are performed by the occupant. Thereafter, the process proceeds to step S103.

Step S103: The control content specifying unit 6 selects, based on the posture of the occupant or the change in posture discerned in step S102, the display 30 as a candidate to be controlled from among the displays 30 to be subjected to display control defined in the discernment information prepared in advance. Thereafter, the process proceeds to step S104.

Step S104: The vehicle state acquisition unit 4 acquires a signal indicating the state of the vehicle or the state of the vicinity of the vehicle from the various sensors installed in the vehicle, the cameras (that may include vehicle-mounted cameras 20), the global positioning system (GPS), or the like. Thereafter, the process proceeds to step S105.

Step S105: The vehicle state discernment unit 5 discerns the state of the vehicle or the state of the vicinity of the vehicle based on the signal acquired by the vehicle state acquisition unit 4. Examples of the state of the vehicle are a state of moving forward, a state of moving backward, a state of turning right or left, and a state of passing another vehicle and the state of the vehicle can be discerned based on a vehicle speed, a shift position, the output of a switch of a direction indicator, or the like. Examples of the state of the vicinity of the vehicle are the state of a road on which the vehicle is traveling, presence or absence of a vehicle approaching, the intensity of light from the outside, the weather, or the like and the state of the vicinity of the vehicle can be discerned based on position information, car navigation map information, an image captured by a camera, and signals output from an illuminance sensor, a ultrasonic sensor, a radar, and the like. Thereafter, the process proceeds to step S106.

Step S106: The control content specifying unit 6 predicts the prospective state of the vehicle or the prospective state of the vicinity of the vehicle based on the state of the vehicle or the state of the vicinity of the vehicle discerned by the vehicle state discernment unit 5. Thereafter, the process proceeds to step S107.

Step S107: The control content specifying unit 6 specifies a control type corresponding to one or both of the result of the discernment in step S105 and the result of the prediction in step S106 from among one or more control types assigned to the candidate to be controlled which is selected in step S103. Accordingly, the display 30 to be controlled is also specified. Thereafter, the process proceeds to step S108.

Step S108: The control content specifying unit 6 determines whether a control in which the display 30 specified in step S107 is caused to display content to be displayed which is set for the specified control type can be performed or not. Specifically, in the present step, the vehicle state acquisition unit 4 acquires a signal indicating the state of the vehicle or the state of the vicinity of the vehicle again and the vehicle state discernment unit 5 discerns the state of the vehicle or the state of the vicinity of the vehicle such that a determination on whether the prospective state of the vehicle or the prospective state of the vicinity of the vehicle that is predicted in step S106 has been realized or not after step S107 is performed. In a case where the prospective state of the vehicle or the prospective state of the vicinity of the vehicle that is predicted in step S106 coincides with the state of the vehicle or the state of the vicinity of the vehicle after step S107, the control content specifying unit 6 determines that it is possible to control the display 30 to be controlled (YES in S108) and the process proceeds to step S109. Otherwise (NO in S108), the process proceeds to step S101.

Step S109: The controller 7 controls display change of the display 30 to be controlled based on the control type specified in step S107. Thereafter, the process proceeds to step S101.

Next, specific examples of steps S101 to S109 in FIG. 3 will be described. Here, an example of a case where the occupant tries to move the vehicle backward will be described. In addition, it will be assumed that the discernment information as shown in FIGS. 2A and 2B is used as discernment information for specifying the display 30 to be controlled and the type of control to be performed on the display 30 to be controlled.

First, based on an image of the occupant, the posture discernment unit 3 discerns that the face of the occupant is facing a right side and there has been a change from a normal driving posture to a posture of looking at a side that is to the right of the vehicle (Steps S101 and S102). Next, based on the discernment information, a determination is made that the posture of the occupant and a change in posture correspond to “posture or change in posture as reason for selection: orientation of face (direction to right side), posture (looking at side that is to right of vehicle)” in FIG. 2A and thus targets to be controlled are narrowed down to the “target to be controlled: electronic side mirror (right)” (step S103). Next, the vehicle state acquisition unit 4 acquires a signal indicating that a shift position is in an R range and the vehicle state discernment unit 5 discerns that the state of the vehicle is a state where the shift position thereof is in the R range (steps S104 and S105). As a result, the vehicle is predicted to move backward in the future (step S106). Since the result of the above-described prediction corresponds to “vehicle state and vehicle state prediction: R range” in “vehicle state and vehicle state prediction” corresponding to “target to be controlled: electronic side mirror (right)” in FIG. 2A, “electronic side mirror (right)” is specified as the display 30 to be controlled and “low-side wide-angle displaying operation” is specified as a control type (S107). Then, when the vehicle actually starts to move backward, the control content specifying unit 6 determines that the specified type of control can be performed on the specified target to be controlled and control in which the electronic side mirror (right) performs a low-side wide-angle displaying operation is performed (steps S108 and S109).

In addition, other specific examples of steps S101 to S109 in FIG. 3 will be described. Here, an example of a case where the occupant tries to cause the vehicle to turn right or to move to a right lane.

First, based on an image of the occupant, the posture discernment unit 3 discerns that the face of the occupant is facing a right side and there has been a change from a normal driving posture to a posture of looking at a side that is to the right of the vehicle (Steps S101 and S102). Next, based on the discernment information, a determination is made that the posture of the occupant and a change in posture correspond to “posture or change in posture as reason for selection: orientation of face (direction to right side), posture (looking at side that is to right of vehicle)” in FIG. 2A and thus targets to be controlled are narrowed down to the “target to be controlled: electronic side mirror (right)” (step S103). Next, the vehicle state acquisition unit 4 acquires a signal indicating that a right-turn blinker is on and the vehicle state discernment unit 5 discerns that the state of the vehicle is a state where the right-turn blinker is on (steps S104 and S105). As a result, the vehicle is predicted to turn right in the future (step S106). Since the result of the above-described prediction corresponds to “vehicle state and vehicle state prediction: turn-right (blinker) instruction” in “vehicle state and vehicle state prediction” corresponding to “target to be controlled: electronic side mirror (right)” in FIG. 2A, “electronic side mirror (right)” is specified as the display 30 to be controlled and “right-side displaying operation at time of turning right or moving to right lane” is specified as control type (S107). Then, when a steering wheel actually starts to be rotated right, the control content specifying unit 6 determines that the specified type of control can be performed on the specified target to be controlled and control in which the electronic side mirror (right) performs a right-side displaying operation is performed (steps S108 and S109). Although an example where the right-side displaying operation is performed as a type of control to be performed in a case of turning right or moving to a right lane has been described, a right-side wide-angle displaying operation may be performed instead of right-side displaying operation and in a case where an obstacle such as a bicycle, a motorcycle, or a pedestrian is present on a right side, the obstacle may be highlighted. Hereinabove, the processes in steps S101 to S109 in FIG. 3 have been described while the processes in step S106 and step S108 can be omitted. However, when the prospective state of the vehicle or the prospective state of the vicinity of the vehicle is predicted in step S106, a possibility that the control device 1 can finish a process of specifying the content of control before a time at which the display 30 needs to be controlled is increased. Therefore, control can be more reliably started before a time at which the control needs to be performed and thus it is possible to restrain the timing of display change of the display 30 from being later than a timing intended by the occupant. In a case where step S106 is omitted, in step S107, the control content specifying unit 6 specifies a control type corresponding to the result of the discernment in step S105 from among one or more control types assigned to the candidate to be controlled which is selected in step S103.

In addition, even when step S106 is omitted, since the determination on whether control can be performed or not is performed in step S108, the display 30 can be restrained from being subjected to control not intended by a driver based on a momentary vehicle state. Specifically, in a case where a vehicle state discerned in step S105 is maintained until step S108, the control content specifying unit 6 determines that it is possible to control the display 30 (YES in S108). Accordingly, even in a case where a shift position momentarily enters the R range at the time of a shift change and the content of control is specified based on the momentary vehicle state in step S107, control in step S109 is not performed when it is not confirmed that the shift position is in the R range in step S108 as well (corresponding to NO in S108).

In addition, when both of step S106 and step S108 are performed, the display 30 can be restrained from being controlled in a case where the display 30 does not need to be controlled actually as in the case of an erroneous operation of the occupant or the like. For example, a case where the occupant turns on a right blinker by mistake although there is no plan to turn right and the content of control is specified in step S107 based on this vehicle state will be assumed. In a case where the prospective state of the vehicle is predicted to be “turning-right state” in step S106 with the right blinker being turned on, control in step S109 is not performed as long as the vehicle enters a turning-right state in step S108 actually.

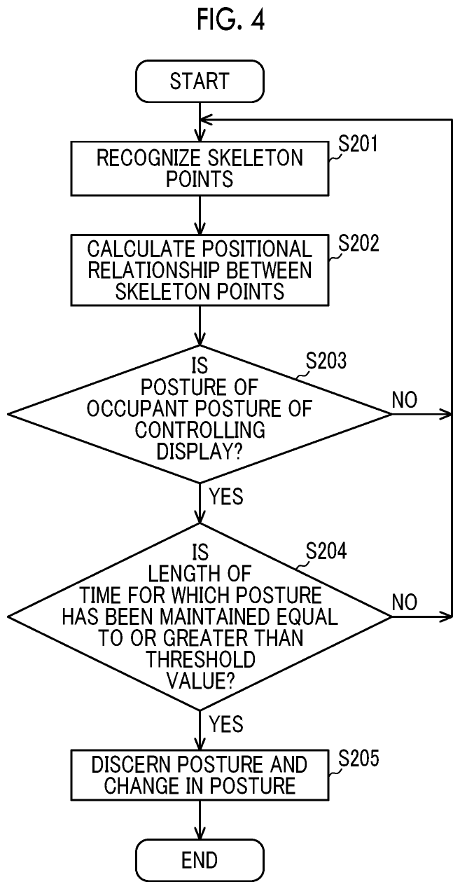

Next, a specific example of a process for discerning the posture, which is performed in step S102 in FIG. 3, will be described with reference to FIG. 4. FIG. 4 is a flowchart for describing the process for discerning the posture. Here, as an example, a method of discerning the posture based on skeleton points of the occupant will be described. The flow in FIG. 4 is started immediately after step S101 in FIG. 3.

Step S201: the posture discernment unit 3 recognizes the skeleton points of the occupant based on the image captured by the occupant imaging unit 2. The skeleton points can be recognized by means of a known skeleton point recognition technique. Thereafter, the process proceeds to step S202.

Step S202: The posture discernment unit 3 represents each of the positions of the skeleton points recognized in step S201 by coordinates and calculates a positional relationship between the skeleton points. Thereafter, the process proceeds to step S203.

Step S203: The posture discernment unit 3 determines whether the posture of the occupant is a posture of controlling the display 30 or not. The posture of controlling the display 30 may be a posture that is set in “posture or change in posture as reason for selection” in the discernment information in advance. The posture of the occupant can be represented by a positional relationship between the skeleton points and may be defined in advance. In a case where the posture of the occupant is a posture of controlling the display 30, (YES in S203), the process proceeds to step S204. Otherwise (NO in S203), the process proceeds to step S201.

Step S204: The posture discernment unit 3 determines whether the length of a time for which the posture of the occupant has been maintained is equal to or greater than a predetermined threshold value or not. By confirming whether a posture has been maintained for a certain time or not, it is possible to restrain a specific momentary posture from being recognized as a posture based on which the display 30 is controlled. The threshold value with respect to the length of a time of maintenance may be set to such a time that a determination on whether or not the occupant is gazing at a specific position on the display 30 or on the outside of the vehicle can be performed, for example. In a case where the length of a time for which the posture of the occupant is maintained is equal to or greater than the predetermined threshold value (YES in S204), the process proceeds to step S205. Otherwise, (NO in S204) the process proceeds to step S201.

Step S205: The posture discernment unit 3 discerns the posture. Thereafter, the process is terminated.

### Other Embodiment

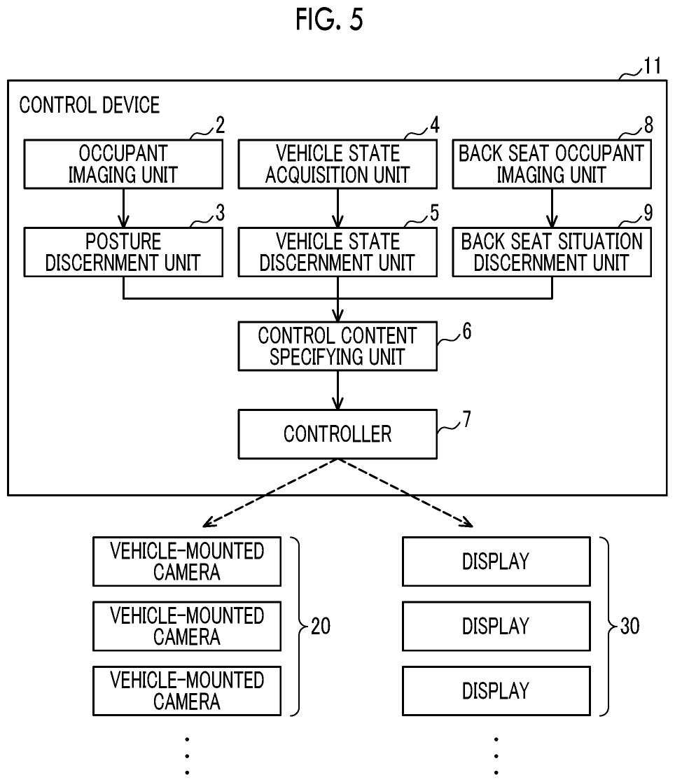

FIG. 5 is a functional block diagram illustrating a control device according to another embodiment of the disclosure. The configuration of a control device 11 according to the other embodiment is a configuration obtained by adding a back seat occupant imaging unit 8 and a back seat situation discernment unit 9 to the configuration of the control device 1. Hereinafter, the description will be made focusing on the configuration obtained through the addition.

The back seat occupant imaging unit 8 is a camera imaging an occupant (back seat occupant) on a back seat of the vehicle and is installed, for example, at the position of an electronic mirror or the top of the inside of the vehicle. The above-described camera is installed separately from the vehicle-mounted cameras 20. The camera may be shared with the occupant imaging unit 2 in a case where the back seat can be imaged.

The back seat situation discernment unit 9 discerns, based on an image captured by the back seat occupant imaging unit 8, the situation of the back seat such as presence or absence of the back seat occupant, the posture of the back seat occupant, and a sitting situation, for example. The situation of the back seat can be discerned by means of the method of discerning the posture and a change in posture in step S102. Note that, presence or absence of the back seat occupant or the sitting situation may be determined based on a combination of image information and information from other devices such as a sitting sensor.

An operation of imaging a back seat occupant that is performed by the back seat occupant imaging unit 8 and an operation of discerning the situation of a back seat that is performed by the back seat situation discernment unit 9 are performed between step S102 and step S103 in the flow shown in FIG. 3, for example. Accordingly, in step S103, the control content specifying unit 6 selects, based on the posture of the occupant or a change in posture and the situation of the back seat, the display 30 as a candidate to be controlled from among the displays 30 to be subjected to display control defined in the discernment information.

Control that is performed in a case where the occupant (front seat occupant) confirms the situation of the back seat by using the electronic inner rearview mirror when the back seat occupant gets on or off the vehicle will be described by using description in the discernment information as shown in FIGS. 2A and 2B as an example. In a case where an occupant is on the back seat, the face of the front seat occupant is facing the electronic inner rearview mirror, and/or the posture is a posture of looking at the electronic inner rearview mirror, a determination is made that the case corresponds to “posture or change in posture as reason for selection: orientation of face (direction to electronic inner rearview mirror), posture (looking at electronic inner rearview mirror), back seat occupant posture” in FIG. 2B and a target to be controlled becomes “target to be controlled: electronic inner rearview mirror”. In addition, in a case where a rear door is open or closed, a determination is made that the case corresponds to “vehicle state and vehicle state prediction: rear door is open or closed” and “control type: back seat displaying operation” is specified. Accordingly, the front seat occupant can confirm the state of the back seat occupant getting on or off the vehicle by means of the electronic inner rearview mirror. Note that, in a case where the display 30 is caused to perform a back seat displaying operation, in consideration of safety, it is desired that control in which the electronic inner rearview mirror is caused to perform the back seat displaying operation becomes not able to be performed in step S108 (corresponding to NO in step S108) such that the control is not performed in a case where the vehicle speed is nor zero or the shift position is not at P.

Operation and Effect

As described above, the control device 1 according to the embodiment of the disclosure controls a displaying operation of the displays 30 based on the posture of an occupant or a change in posture and the state of the vehicle or the state of the vicinity of the vehicle.

Accordingly, the control device 1 can control the displays 30 in consideration of the state of the vehicle and the state of the vicinity of the vehicle in addition to the posture of the occupant and a change in posture and can cause the displays 30 to display an image intended by a driver more appropriately.

The control content specifying unit 6 predicts the prospective state of the vehicle or the prospective state of the vicinity of the vehicle based on the result of the discernment about the state of the vehicle or the state of the vicinity of the vehicle which is performed by the vehicle state discernment unit 5.

Accordingly, it is possible to perform control at a timing intended by the occupant.

The control content specifying unit 6 allows display change of the display 30 that is specified as a target to be controlled by the controller 7 in a case where a determination is made that the prospective state of the vehicle or the prospective state of the vicinity of the vehicle predicted by the control content specifying unit 6 has been realized.

Accordingly, even in a case where the display 30 actually does not need to be controlled such as a case where the occupant operates a device by mistake momentarily, the display 30 can be restrained from being controlled.

The control device 1 in an aspect of the disclosure can be interpreted as a control device, a display control method performed by a computer of the control device, a display control program, a non-transitory computer-readable storage medium storing the display control program, a display control system, a vehicle, or the like.

The disclosure is useful for a control device controlling display change of a display installed in a vehicle or the like.

What is claimed is:

1. A control device installed in a vehicle provided with a plurality of vehicle-mounted cameras and a plurality of displays, the control device being configured to perform control in which at least a portion of an image captured by any of the vehicle-mounted cameras is displayed on any of the displays, the control device comprising:
an occupant imaging unit configured to image an occupant in the vehicle;
a posture discernment unit configured to discern a posture of the occupant or a change in posture based on an image captured by the occupant imaging unit;
a vehicle state acquisition unit configured to acquire a signal indicating a state of the vehicle or a state of a vicinity of the vehicle;
a vehicle state discernment unit configured to discern the state of the vehicle or the state of the vicinity of the vehicle based on the signal acquired by the vehicle state acquisition unit;
a control content specifying unit configured to specify a display to be controlled and content to be displayed on the display based on a result of the discernment performed by the posture discernment unit and the vehicle state discernment unit; and
a controller configured to control display change of the display to be controlled based on a result of the specification performed by the control content specifying unit.

2. The control device according to claim 1, wherein:
the control content specifying unit predicts a prospective state of the vehicle or a prospective state of the vicinity of the vehicle based on the state of the vehicle or the state of the vicinity of the vehicle discerned by the vehicle state discernment unit and specifies a display to be controlled and content to be displayed on the display based on a result of the prediction.

3. The control device according to claim 2, wherein the control content specifying unit allows display change of a display specified as a target to be controlled in a case where a determination is made that the prospective state of the vehicle or the prospective state of the vicinity of the vehicle coincides with the state of the vehicle or the state of the vicinity of the vehicle discerned by the vehicle state discernment unit after the prospective state of the vehicle or the prospective state of the vicinity of the vehicle is predicted.
